(19) United States
(12) Patent Application Publication
(10) Pub. No.: US 2002/0150056 A1
(43) Pub. Date: Oct. 17, 2002

(54) Method for avoiding broadcast deadlocks in a mesh-connected network

(76) Inventors: Martin Abadi, Palo Alto, CA (US); Thomas Lee Rodeheffer, Mountain View, CA (US)

Correspondence Address: OPPENHEIMER WOLFF & DONNELLY, P. O. BOX 10356, PALO ALTO, CA, 94303, US

(21) Appl. No.: 10/076,820

(22) Filed: Feb. 15, 2002

Related U.S. Application Data
(63) Continuation-in-part of application No. 09/079,543, filed on May 15, 1998.

(51) Int. Cl. H04L 12/28

(52) U.S. Cl. 370/256

(57) ABSTRACT

A method for broadcasting packets in a network that includes a plurality of switches. The network can logically be represented by a spanning tree plus cross-links. In order to avoid deadlock during a broadcast, a broadcast packet is sent from an originating switch to a root switch of the network, and a copy of the packet is sent from a current switch to all descendant switches when all copies of the packet have been received in the current switch.

### CROSS-REFERENCE TO RELATED APPLICATIONS

This application is a continuation-in-part of prior U.S. Application, entitled “METHOD FOR AVOIDING BROADCAST DEADLOCKS IN A MESH-CONNECTED NETWORK”, Ser. No. 09/079,543, filed on May 15, 1998, which application is incorporated by reference into the present application. The present Application further claims the benefit of the filing date of the aforementioned U.S. Application.

### FIELD OF THE INVENTION

This invention relates generally to broadcasting packets in a communications network including switches, and more particularly to avoiding deadlock during a broadcast of packets.

### BACKGROUND OF THE INVENTION

One type of local areas mesh-connected network that can be used to broadcast message packets is called a cut-through network. In a cut-through network, switches forward packets from sources to destinations without necessarily storing complete packets in switch buffers at any point in time. Cut-through networks are contrasted with traditional store-and-forward networks where each packet is fully buffered in each switch through which the packet passes.

Cut through networks offer advantages in performance and cost. In a cut-through network, a spanning tree may be defined. A spanning tree can be represented as a graph of nodes and edges where the nodes represent the switches, and the links represent links between the switches. Point-to-point packets can be forwarded both on spanning-tree links, and on cross-links. Cross-links are links that are not part of the spanning tree. The use of all links, including cross-links, offers advantages in utilization for point-to-point communication.

One cut-through network in the “AN1” network, originally known as “Autonet.” This is a high-speed, self-configuring local area network. This network is described by Schroeder et al. in Autonet: A High-speed, Self-configuring Local Area Network Using Point-to-Point Links,” SRC Research Report 59, Apr. 30, 1990. See also, Schroeder et al., “A High-speed mesh-connected local area network,” U.S. Pat. No. 5,088,091, issued Feb. 11, 1992, which patent is hereby incorporated by reference into the present application.

In a cut-through network such as the Autonet, broadcast packets are directly forwarded “up” the spanning tree to the root switch, and from there the broadcast packet is “flooded” “down” the spanning tree to all destinations. Cross-links are not used. Here, “flooding” means that the broadcast packet is replicated on all spanning tree links leading “downward” out of a switch. The terms up and down are used to indicate that the-links in the spanning tree have some determinable ordering.

The AN1 or Autonet network avoids deadlocks by placing restrictions on when broadcast packet can be stopped, and ensuring that the buffers are big enough to hold all of any broadcast packet. For non-broadcast packets it may be inconvenient or impractical to place a limit on their lengths. The prior approach limits the maximum length of broadcast packets to no more than ½ of the buffer size at switches. The limit on broadcast packets complicates host and bridge network software, especially if the maximum length of a broadcast packet is less than the maximum length of a non-broadcast packet. The minimum requirement of buffer space can make the switches more expensive. The deadlock problems of the prior art network are described in detail in Section 6.6.6 of SRC Research Report 59.

Therefore, there is a need for a network that avoids deadlock during the broadcast of packets without having any size restrictions on buffers used in the network to store the packets during the broadcast.

### SUMMARY OF THE INVENTION

The invention provides a method and apparatus for broadcasting packets in a network including a plurality of switches. The network is a cut-through network that can logically be represented by a spanning tree and cross-links.

A broadcast packet is directly sent from an originating switch to the root switch of the network. At this point the root switch can be considered the current switch.

Copies of the packet are sent from the current switch to all descendant switches when all copies of the packet have been received in the current switch to avoid deadlock during the broadcasting of the packets. Descendant switches are those switches that are connected by downward directed links from the current switch. A downward directed link can be a spanning tree link or a cross-link.

In one aspect of the invention, the current switch simultaneously sends the copies of the packet to the descendant switches. In another aspect, the copies of the packet sent on cross-links are represented by tokens identifying the packet.

In case of a network failure the network is initialized by propagating an initialization state to all switches, collecting the network topology, distributing the network topology to all switches, and waiting until all switches are initialized before resuming operation.

An apparatus in accordance with one embodiment of the present invention is a switch for a mesh-connected network, that is logically represented by a spanning tree with cross-links, the spanning tree identifying therein a root switch and a plurality of other switches. The switch includes a plurality of switch ports that are each configured to connect to a link in the network and to receive, in a broadcast, from a connected link, a copy of a broadcast packet from each switch for which the switch is a descendent switch. The switch further includes a crossbar connection unit that is connected to the routing logic circuit and the plurality of switch ports, and configured, in a broadcast, to forward, from a selected switch port, copies of the broadcast packet of the broadcast to any ports having connected links to descendents of the switch in the network. The switch also includes a routing logic circuit that is connected to the crossbar connection unit to control the routing of packets in the crossbar connection unit, and configured, in a broadcast, to select one of the switch ports that has a copy of the broadcast packet of the broadcast and any other ports as output ports for transmitting the selected copy of the broadcast packet to descendents of the switch.

One advantage is that broadcasts in a mesh network are serialized by the switch so that only one broadcast packet at a time can descend down the spanning tree from the root.

Another advantage of the present invention is that multiple broadcasts can occur in a mesh network without the possibility of a deadlock.

### BRIEF DESCRIPTION OF THE DRAWINGS

FIG. 1 is a block diagram of a switch in accordance with the present invention;

FIG. 2 is a block diagram of the crossbar switch used in the present invention;

FIG. 3 is a block diagram of two connected link units in a switch;

FIG. 4 shows additional details of the link unit circuitry;

FIG. 5 shows the basic components of the router circuit used in the preferred embodiment;

FIG. 6 shows a network 100 that includes a plurality of routing switches;

FIG. 7 is a more detailed diagram of a section of a local area network in accordance with the present invention;

FIG. 8 shows a spanning tree that logically represents the network of FIG. 6;

FIG. 9 is a logical structure for illustrating the up/down rule;

FIG. 10 shows the steps of a method for broadcasting packets in a cut-through network that avoids deadlocks;

FIG. 11 illustrates the serialization of broadcasts; and

FIG. 12 illustrates steps involved in initializing the network.

### DETAILED DESCRIPTION OF PREFERRED EMBODIMENTS

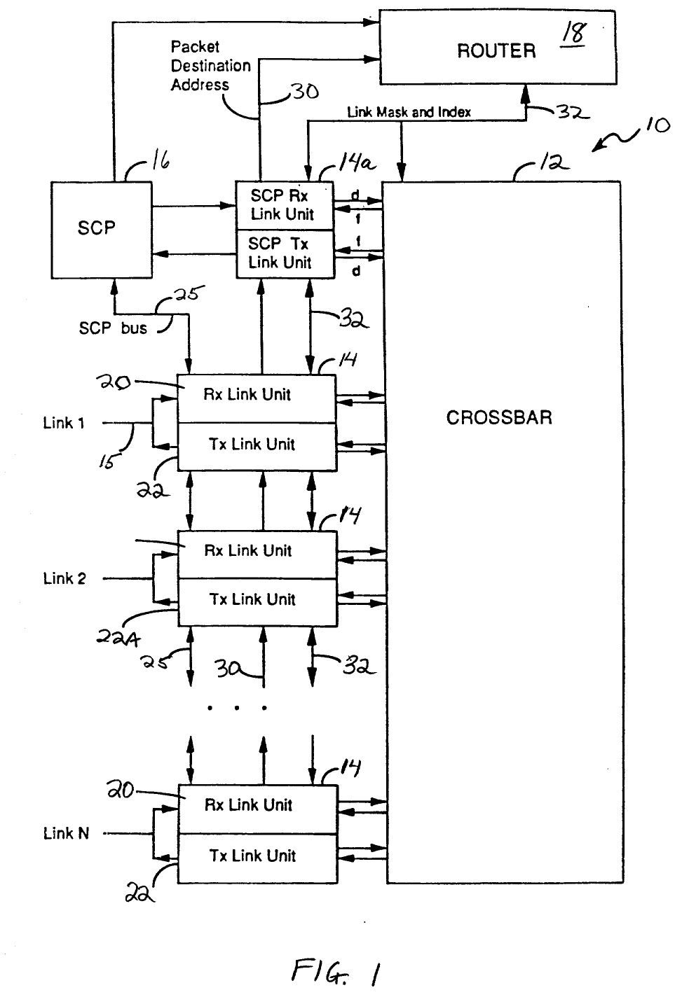

FIG. 1 is a block diagram of a switch in accordance with the present invention. The primary components of the switch 10 are a non-blocking crossbar switch 12, a number (twelve in the preferred embodiment) of switch ports 14, which are also called link control units, a switch control processor (SCP) 16, and a router 18, which is also called the routing logic circuit. There is also a special link circuit 14a for coupling the SCP 16 to the crossbar 12.

Each link unit 14 connects the crossbar 12 to one full duplex link 15. Each link 15 has two data channels so that data can be simultaneously transmitted in both directions over the link 15. Therefore, each link unit 14 has two components: an input link unit 20 (Rx) and an output link unit 22 (Tx).

When a new data packet is received by the switch 10, the input link unit 20 that receives the data packet is connected by the crossbar 12 to an output link unit 22A (for a different link than the receiving input link). The output link unit 22 transmits the received data packet over another link, and thereby forwards the packet towards its destination. The crossbar 12 is designed so that it can simultaneously couple any or all of the input link units 20 to distinct sets of output link units 22.

The router 18 determines which output link unit 22 should be coupled to each input link unit 20. When a new data packet is received by an input link unit 20, the input link unit 20 sends a routing request to the router 18. The routing request specifies the destination of the packet, as well as the identity of the input link unit. As shown in FIG. 1, the link unit 20 sends the packet's destination address to the router 18 over bus 30. The destination address of the packet is stored at the beginning of each packet in a few bytes that specify the network member to which the packet is being sent.

Another bus 32 carries a link mask with one bit corresponding to each of the link units, plus a four bit link index, a broadcast bit and a valid flag. Each of the lines of the link mask portion of bus 32 can be thought of as a single bit communication line between the router 18 and one of the link units 14.

An availability flag is periodically sent by each output link unit 22 to the router 18. The availability flag is ON when the output link is not busy and is “not blocked” and is therefore available for routing a new data packet. An output link unit is blocked when the switch on the other end of the link (i.e., the link coupled to the output link) unit has sent a Stop flow command. The Stop flow command indicates that the switch on the other side of the link is not ready to receive more data. When the output link unit 22 is busy or blocked, its availability mask is OFF. The thirteen availability mask bits from the output link units 22 are periodically sampled by the router 18 and then used to make a route selection.

Using the information sent by the input link unit 20, the router 18 determines which output link unit(s) 22 should be used to re-transmit the data packet. The routing selection made by the router 18 is transmitted over the router bus 32 to the link units 14 and crossbar 12 which use the routing selection to set up the appropriate connections in the crossbar 12.

A preferred embodiment of the circuitry for the router 18 is described in U.S. patent application Ser. No. 07/370,248, entitled ROUTING APPARATUS AND METHOD FOR HIGH-SPEED MESH CONNECTED LOCAL AREA NETWORK, which is incorporated by reference.

It is noted that while the initial preferred embodiment has only a dozen switch ports (i.e., link units) 14, it is anticipated that future units may have larger numbers of such ports.

The SCP 16 is a standard microprocessor (e.g., a 68010 microprocessor made by Motorola is used in the preferred embodiment) which is programmed to initialize the router 18 whenever the switch 10 is powered up or reset, and to perform a reconfiguration program whenever a component of the network fails or a new component is added to the network. The SCP is connected to all the link units 14 by the SCP bus 25 so that the SCP can monitor the status of the link units and can identify units which are not connected to a link and units which are malfunctioning.

Link unit 14a interconnects the switch control processor (SCP) 16 and the crossbar 12 so that the SCP 16 can send and receive data packets via the crossbar 12 using the same communication mechanisms as the host computers in the network. During reconfiguration of the network, the SCP 16 sends data packets to the SCPs in the neighboring switches to determine the topology of the network, and to generate a new set of routing tables for the routers in the network's switches.

Connections between input link units 20 and output link units are made by the crossbar 12 as follows. Generally, each time that the router 18 issues a new link selection, two multiplexers inside the crossbar are set so that a selected input link unit is connected to a selected output link unit. Two multiplexers are needed because one transmits data from the input link unit to the output link unit, while the other multiplexer transmits flow control signals back to the input link unit. When broadcast packets are transmitted, the number of multiplexers set up by the link selection signals depends on the number of output links being used.

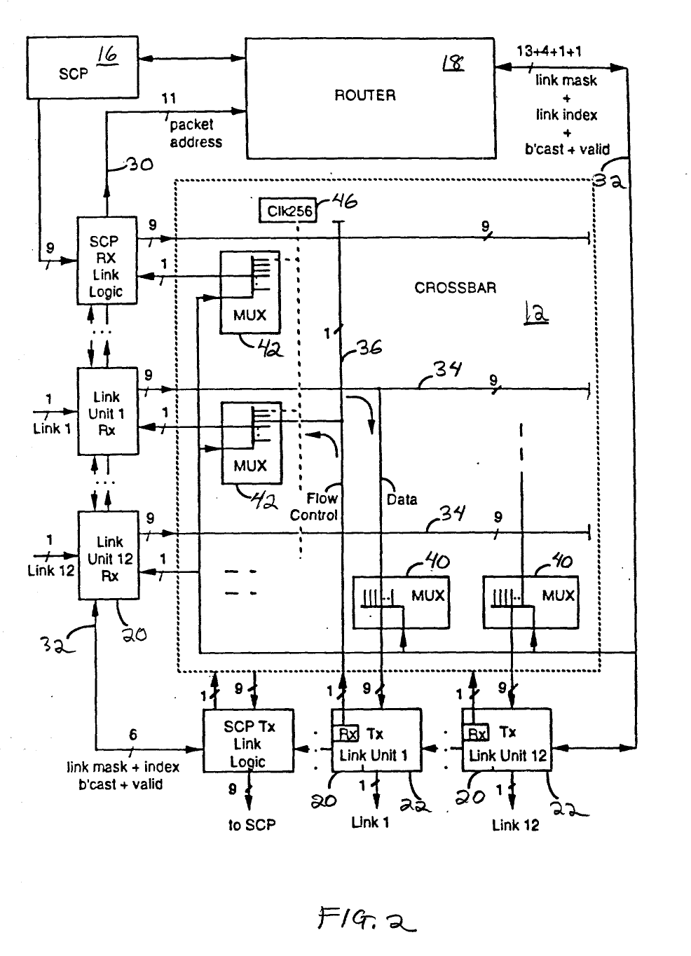

FIG. 2 is a block diagram of the crossbar switch used in the present invention. In FIG. 2, the input and output portions 20 and 22 of each link unit have been separated so as to show their logical relationship to the crossbar 12. The input link units 20 are shown along the left side of the crossbar 12 while the output link units 22 are shown along the bottom of the crossbar 12. However, as will be explained below, the circuitry of these two units 20 and 22 is interconnected and the control logic for the two is not entirely separate. In addition, solely for the purposes of this one drawing, each input link unit 20 is shown a second time at the bottom of the crossbar 12 for reasons which will soon be explained.

As shown in FIG. 2, each input link unit is coupled to a 9-bit wide data path 34 and 1-bit wide flow control line 36. The data path 34 carries data from data packets, and the flow control line 36 carries flow control information.

The crossbar 12 includes two multiplexers 40 and 42 for each link unit 14. The first multiplexer 40, called the data transmission multiplexer, connects a corresponding output link unit 22 to a selected one of the data paths 34. Because there are as many data transmission multiplexers 40 as there are link units 14, several or even all of the output link units 22 can be simultaneously connected to corresponding selected ones of the input link units 20. In other words, the crossbar 12 is a non-blocking switch which can simultaneously route many packets.

In addition, it can be seen that two or more of the transmitting link units 22 can be coupled to the same data path 34 simply by causing their data transmission multiplexers 40 to select the same data path. This latter capability is used when broadcasting data packets to all the hosts on the network.

The second multiplexer 42, called a flow control multiplexer, couples a corresponding input link unit 20 to a selected one of the flow control lines 36. In other words, the flow control commands received by one output link unit 22 are transmitted via the crossbar 12 to the control circuitry in one of the input link units. Since there are as many flow control multiplexers 42 as there are link units 14, each input link unit 20 can be simultaneously coupled to a corresponding selected one of the other link units 14.

Each multiplexer 40 and 42 has an associated selection register (not shown) which is used to store a four-bit selection value that is sent to it by the router 18. These selection values determine which data path and flow control lines will be coupled to each of the link units.

In summary, the crossbar has one multiplexer 40 or 42 for directing data or flow commands to each of the input and output link units 20 and 22.

The selection signals for the multiplexers 40 and 42 are generated and transmitted on router bus 32 by the router 18. Every time that the beginning of a new packet reaches the front of the FIFO buffer in an input link unit 20, the input link unit 20 transmits a routing request to the router 18 via bus line 30. The router responds to routing requests by generating and transmitting a multiplexer control signal over the router bus 32. The router bus 32 has the following components: link mask; link index; broadcast flag; and router bus valid flag.

The output link mask contains a separate ON/OFF flag for each of the output link units 22. Each output link 22 having a mask flag with a value of “1” will be coupled to a specified input link unit. The broadcast flag is set when a broadcast packet is being simultaneously routed to a plurality of network members. The router bus valid flag is set whenever the router 18 is asserting a route selection on the bus 32, and is reset otherwise.

The link mask portion of the router bus 32 is used to transmit bits corresponding to the selected output links, and the link index is a four-bit value that identifies the input link unit. The crossbar uses the four-bit link index as the multiplexer selection signal for the data transmission multiplexer(s) 40 coupled to the selected output link unit(s). For example, if the link mask has a “1” flag for output link unit 5 and the input link selection has a value of 0011 (i.e., 3), the value 0011 is used as the selection signal for the multiplexer 40 associated with the fifth output link unit 22. If the output link mask has a “1” flag for several output link units, then the input link selection value is used for each corresponding multiplexer.

The link index value that is transmitted by the router 18 is also used for setting up the flow control multiplexers 42. To do this, when the valid bit is ON, the crossbar circuit 12 remembers the link mask and link index which were sent by the router 18 and then sets up the flow control multiplexer 42 for the input link specified by the link index value. When the broadcast bit on the router bus is OFF, the selection value loaded in the flow control multiplexer 42 corresponds to the output link identified on the link mask portion of the bus.

When a data packet received by the input link unit 20 is being broadcast to more than one output link mask, the broadcast bit on the router bus is ON, and the selection value loaded into the flow control multiplexer 25 is a special value (e.g., 15). This causes the input link unit to use a special clock signal from a clock generator, called Clk256, in place of the normal flow control signals. As explained earlier, a broadcast packets are transmitted without regard to the normal flow control signals.

In summary, the router 18 transmits link selection values over bus 32, which is used by the crossbar circuit 12 to store corresponding values in the selection registers of the crossbar's multiplexers 40 and 42, and thereby causes the crossbar to connect the selected input and output link units.

The link selection values sent on the router bus 32 are also monitored by the input and output link units so as to coordinate the transmission of data packets through the crossbar 12 and then through the output link unit to another network member.

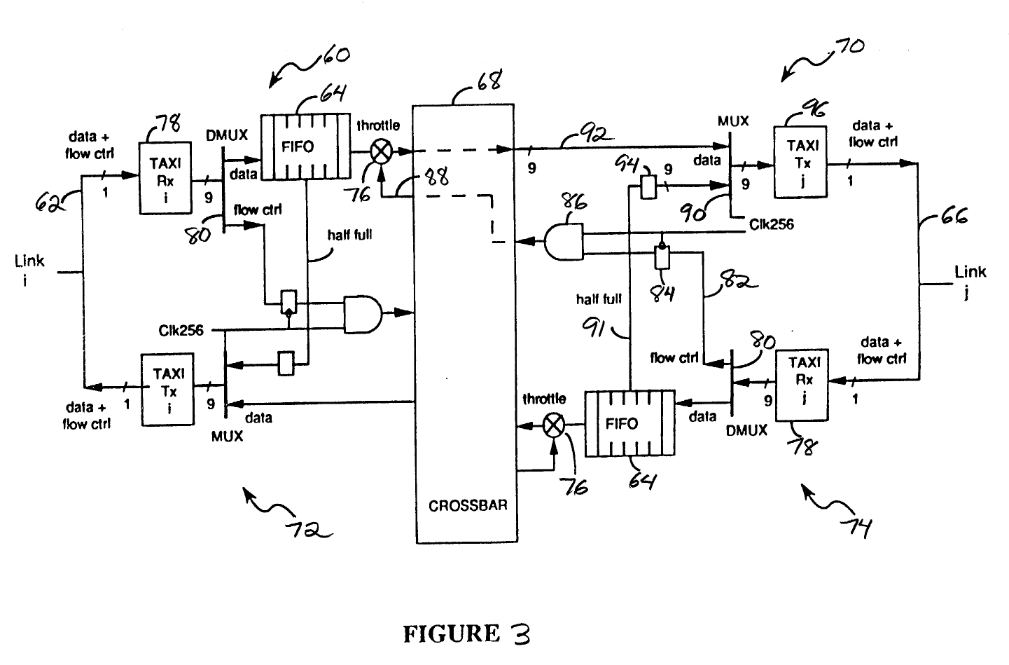

FIG. 3 is a block diagram of two connected link units in a switch and provides a more detailed picture of the input and output link units. Each input link unit 60 and 74 includes a TAXI receiver chip 78 that converts the bit serial data received over an incoming link 62 or 66 into a 9-bit parallel signal that is transmitted over a 9-bit wide bus to a demultiplexer 80. Each byte of data contains a data type-flag, indicating whether the byte is data or a command, which comprises the ninth bit of each byte.

The demultiplexer 80 monitors the type-flag of the signals received from the TAXI Rx circuit 78, and splits off commands in the data stream from data. Data signals, as well as end of packet “command bytes,” are stored in the FIFO buffer 64. Flow control commands received over the link 66 are converted into a binary signal which is transmitted on line 82. The flow control command on line 82 is latched in a latch 84 that is clocked with the transmission clock Clk256 of the corresponding output link unit 70. The latched flow control signal is then ANDed by AND gate 86 with the transmission clock CLk256, and the resulting signal is sent through the crossbar 68 for transmission to another input link unit 60. The output of the AND gate 86 is coupled by the crossbar 68 to throttle control line 76 in input link unit 60.

The latch 84 and AND gate 86 cause the flow control signals sent to the input link unit 60 to be synchronized with the transmission clock of the output link unit 70. In addition, the AND gate 86 causes the transmitted flow command to be OFF once every 256 bytes so as to stop the transmission of data through the crossbar 68 for one byte, during which time the output link unit 70 transmits a flow control signal instead of data. In essence, the output link unit 70 puts out a “stop flow” command on throttle control line 88 every 256th byte cycle, as determined by clock Clk256, so that the throttle 76 of the corresponding FIFO buffer 64 will not send data during the flow control cycle of the switch.

Thus, as described above, flow control signals received by an input link unit are latched and synchronized by the corresponding output link unit, and are then used to start and stop the flow of data through that output link unit.

Each output link unit 70 converts the 9-bit parallel signals received from the crossbar 68 into bit serial signals that are transmitted over an output link 66. More specifically, the output link unit 70 contains a multiplexer 90 connected to clock Clk256, which alternately enables the transmission of data from line 92 for 255 data byte cycles, and then enables the transmission of one flow command byte. A clock with the same period as Clk256 is connected to the demultiplexer 80 so that the FIFO buffer 64 does not, on average, fill faster than it can be emptied.

The multiplexer 90 derives the flow commands that it sends from the status of line 91. Line 91 carries the half-full flag generated by the FIFO buffer 64 in the input link unit 74. Generally, when the FIFO buffer 64 is at least half-full, an ON (i.e., STOP) signal will be sent on line 91, and otherwise an OFF (i.e., START) signal will be sent on line 91. The signal on 91 is converted by an encoder circuit 94 into a nine-bit “stop flow” or “start flow” command for transmission by the Taxi Tx circuit 96.

The data and flow commands output by the multiplexer 90 are converted into a bit-serial data stream by TAXI transmitter 96, which transmits the multiplexed data and commands over link 66.

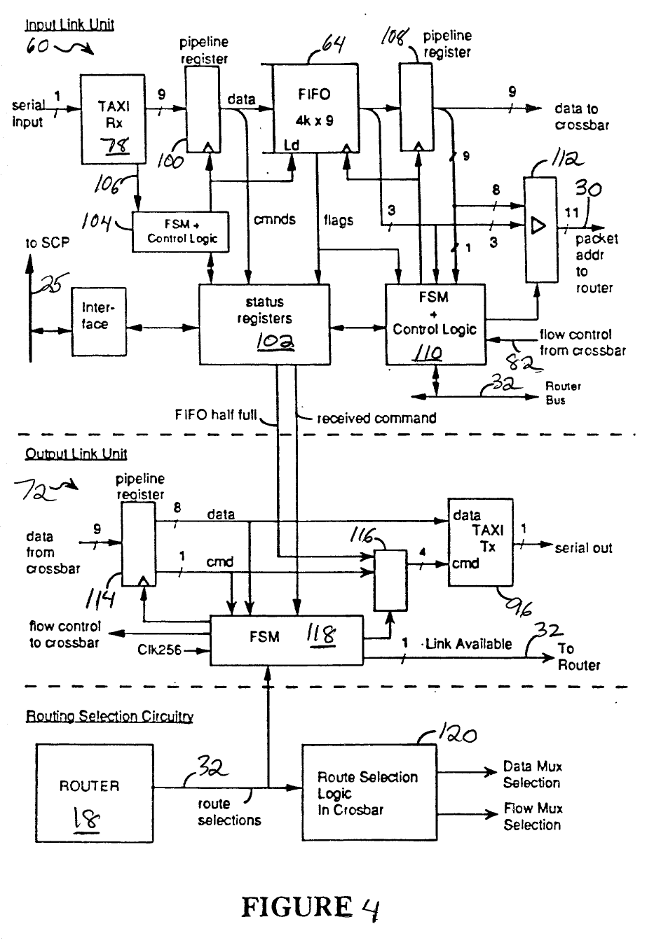

FIG. 4 shows additional details of the link unit circuitry. The demultiplexer 80 in input link unit 60 as shown in FIG. 3 is shown in FIG. 4 to be implemented using a pipeline register 100, status registers 102, and control logic 104. All received data is stored for one byte cycle in the pipeline register 100, which gives the control logic 104 time to determine whether each byte should be loaded into the FIFO buffer 64. Flow commands are decoded and stored in the status registers 102. The control logic 104 receives a clock signal on line 106 that is synchronized with the data being received. This clock signal is generated by The TAXI Rx circuit 78. The control logic 104 reads the status registers 102 and disables the loading of data into the FIFO buffer 64 when certain commands are received. More generally, the control logic 104 is a finite state machine which generates a set of clocks signals that are used to control the flow of data through the part of the input link unit up to and including the input port of the FIFO buffer 64.

It should be noted that the input side of the FIFO buffer 64 is clocked by signals synchronized with the data being received by TAXI Rx circuit 78, while the output side of the FIFO buffer 64 is clocked by a different clock signal generated by an independent clock circuit in the switch. The two clock rates are approximately equal, within about 0.02%, but are not synchronized.

With the assistance of a sequence of pipeline register 108 at the output of the FIFO buffer 64, a second control logic circuit 110 identifies the beginning of each new packet, which contains the packet's destination address. The packet's destination address is sent to the router via buffer 112.

The throttle 76 shown in FIG. 3 is implemented by the control logic 110 which generates the output clock signals for the FIFO buffer 64 and pipeline register 108. The control logic 110 receives flow control signals from line 82. The received flow control signals are transmitted through the crossbar by another input link unit. When a stop flow command is received, the control logic 110 simply disables the output clock signal for the FIFO buffer 64 and pipeline register 108, thereby halting the flow of data out of the FIFO buffer 64.

The control logic 110 also monitors the data/command bit of each 9-bit byte of data as it is read out of the FIFO buffer 64 so as to identify the end of each packet. Only data and end of packet command bytes are stored in the FIFO buffer 64. Therefore, the end of a packet is detected by the control logic 110 when an enabled command bit is read from the FIFO buffer 64. After the end of each packet, the control logic 110 waits until the current packet has cleared the pipeline, and then begins looking for a new data packet to be forwarded.

The control logic 110 interacts with the router 18 via the router bus 32. When the beginning of a new packet is detected, the control logic 110 sends a routing request signal on the link mask portion of the router bus 32 and receives a “grant” signal on the same link mask portion of the router bus during a later time slot. When a grant signal is received, the packet destination address for the new packet is asserted by buffer 112 on bus 30. The control logic 110 also synchronizes the transmission of a new data packet with routing selection signals sent by the router on bus 32.

Both logic circuits 104 and 110 store status signals in the status registers 102 indicating the current status of the input link unit 60. The switch control processor (SCP) periodically reads some of the status values stored in the status registers 102 to determine which link units are coupled to a live link and which link units are working properly.

The output link unit 72, as shown in FIG. 4, consists of a pipeline register 114, a decoder 116, a finite state machine (FSM) 118, and a TAXI transmitter 96. Data from the crossbar is held for one clock cycle in the pipeline register 114 to allow setup of decoder 116, as required by the TAXI timing specifications. Whenever an end of packet command byte is received in the pipeline register 114, the FSM 118 recognizes that command and changes its internal state. Thereafter, if the corresponding output link is not blocked by STOP flow control signals received by the input link unit 60, the FSM 118 then sends out a “link available” signal to the router 18 so that the router will know that this link is available for routing a new packet. The FSM 118 also commands the TAXI Rx circuit 96 to send out an end of packet command byte and then commands the TAXI 96 to transmit synchronization bytes until the router 18 reconnects the output link 72 to an input link for transmitting another packet.

The decoder 116, in conjunction with the FSM 118, acts as the multiplexer 90 of FIG. 3. In particular, the FSM 118 uses the Clk256 clock signal to determine when the TAXI transmits data from the crossbar and when it transmits flow commands. The decoder 116 receives the FIFO half-full status signal from the input link unit. During each time period for transmitting a flow control signal, the decoder 116 decodes the FIFO half-full signal so as to form an appropriate command for the TAXI 96. At the beginning of each packet it forms a BEGIN command and at the end of each packet the decoder 116 forms an END command. If the output link unit is blocked by a STOP flow command, or if the output link unit is idle, the decoder 116 forms a SYNC command. During all other time periods, the decoder 116 sends a “data transmission” command to the TAXI 96. The FSM 118 determines the status of the output link unit 72 and what command the decoder 116 should send to the TAXI 96.

The output link FSM 118 also synchronizes the transmission of a new data packet with routing selection signals sent by the router on bus 32. The same routing selection signals are used by the route selection logic 120 in the crossbar to set up the data and flow multiplexers for coupling a specified input link unit to one or more specified output link units.

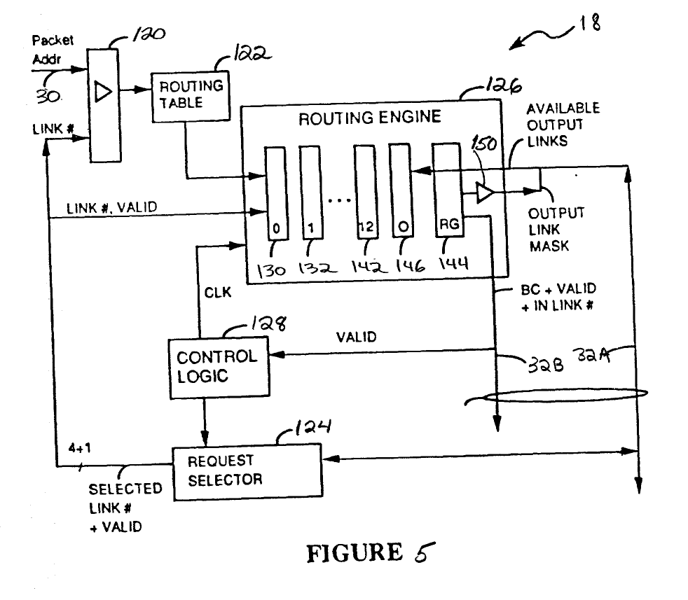

FIG. 5 shows the basic components of the router circuit 18 used in the preferred embodiment. As was shown in FIG. 2, the router 18 receives packet destination addresses on bus 30. Routing requests and output link availability signals are time-multiplexed on router bus 32 along with the transmission of link selection values by the router 18.

Each “routing address” includes an eleven-bit packet address and a four-bit input link number. The routing address is stored in a register 120. A routing table 122 is a look up table which is indexed by routing address values. The routing table 122 contains an entry, for every possible routing address value, which specifies the output links which can be used for routing the packet that corresponds to the routing address.

Whenever an input link unit detects the receipt of a new packet at the output of its FIFO buffer, it sends a request signal on the link mask portion 32A of the router bus 32.

A routing request selector circuit 124 monitors bus 32A to see if any routing requests are being asserted. If one or more routing requests are asserted during any one routing engine cycle, the selector 124 selects one of the requests. The selected request is acknowledged by sending an ON signal on bus 32A to the selected link unit at an appropriate time. This acknowledgment signal instructs the signaled link unit that it has been selected to transmit its routing request over bus 30, and then the selected input link unit sends the packet destination address for its routing request to buffer 120 via bus 30.

The request selector circuit 124 is a cyclic priority encoder, which bases the priority for selecting among competing requests on the last link unit whose request was selected. This ensures that all requests are accepted within a short period of time and helps to prevent packet starvation.

Each routing table address includes an eleven-bit packet destination address received on line 30, and its associated four-bit input link number, which is provided by the request selector circuit 124. The routing table address is stored in a register 120 for use by a routing table 122. The routing table 122 is stored in a random access memory and the fifteen bit value in register 120 is used as the address for retrieving a value (called a routing mask) from the routing table 122. The selected routing mask output by the routing table 122 is latched in by the routing engine 126 at the beginning of the next routing engine cycle, as will be explained in more detail below.

The routing engine 126 is formed from an array of thirteen columns of computational components 130-142, each with nineteen logic blocks. Each of these columns of computational components 130-142 stores and processes a single routing request. In addition, on the right side of the array there is a column 144 of thirteen ready signal generators (RG) and a column 146 of thirteen output signal generators (O).

Routing requests are received on the left side of the array. An output link availability mask is received on the right side of the array 32. The output link availability mask is represented by signals RDY0 through RDY12, and is received from buffer 150 as shown in FIG. 5.

Outputs from the engine 126, which are the routing selections made by the routing engine, emerge on bus 32 from the right side of the array. As described above with reference to FIG. 5, the routing selection contains nineteen bits: a valid bit, indicating a routing selection has been made, a thirteen bit output mask, and the broadcast bit and the four bit input link number from the routing request.

The thirteen columns 130-142 of the array act as a queue which implements the first-come, first-considered routing discipline of the router. The columns at the right side of the queue hold the oldest unsatisfied routing requests, while those on the left hold more recent requests. The entire array works on a periodic clock cycle, the routing engine accepting one routing request per clock cycle and making one attempt to make a routing selection during each clock cycle.

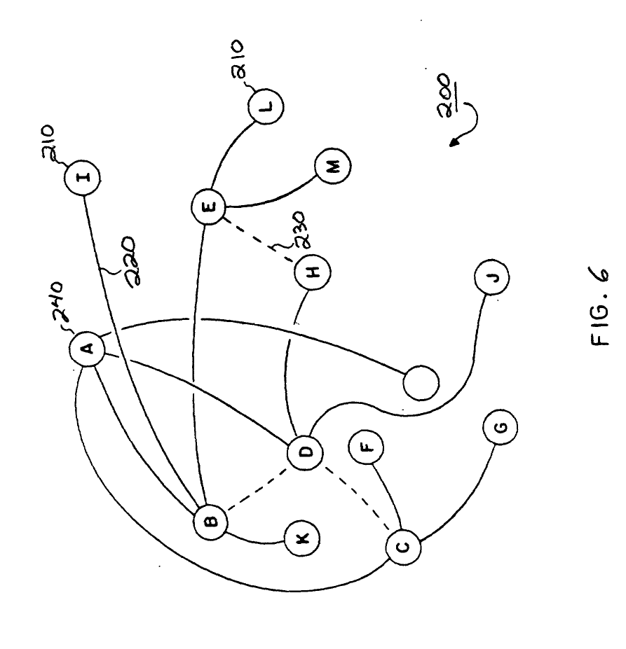

FIG. 6 shows a network 100 that includes a plurality of routing switches 110. The switches 200 are connected by links 220. Some the links are cross-links 230. One switch is designated as a “root” switch 240.

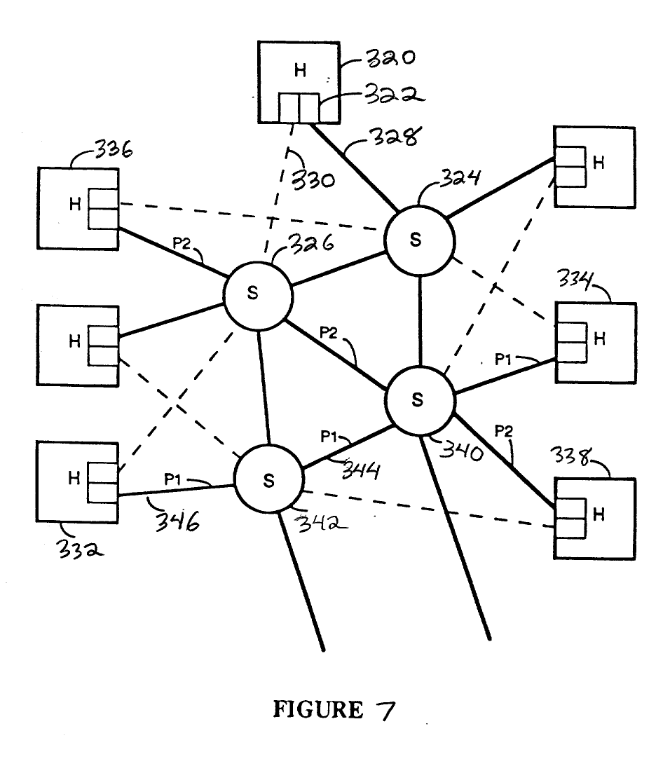

FIG. 7 is a more detailed diagram of a section of a local area network in accordance with the present invention.

Referring to FIG. 7, there is shown one section of a mesh-connected network in accordance with the present invention. In the preferred embodiment, each host 320 in the network has a network controller 322 which couples the host 320 to two distinct switches (e.g., switches 324 and 326 in the case of host 320). The two links 328 and 330 which couple the host 320 to switches 324 and 326 are identical, except that only one of the two links is active at any one time. For this reason link 330 is shown as a dashed line to indicate that it is inactive.

Whenever the active link between a host computer and a switch fails, the host's network controller 322 automatically activates the other link 330, thereby reconnecting the host to the network. In addition, it is strongly preferred that the two links 328 and 330 for each host be coupled to two different switches so that if an entire switch fails all the hosts coupled to that switch will have alternate paths to the network. Generally, the provision of two alternate paths or channels from each host to the network provides sufficient redundancy that no single hardware failure can isolate a host from the network.

It is noted here that each “link” between network members is actually two communications channels which simultaneously carry data in opposite directions. In the preferred embodiment, each link 328 in the network can be up to 100 meters in length when coaxial cable is used, and up to 2 kilometers miles in length when fiber optic cabling is used.

When using coaxial cable, the amount of wiring needed by the network can be reduced by using a single line of cable to simultaneously transmit signals in both directions over the link. At each end of the cable there is a transmitter and a detector. The detector regenerates the signals sent by the transmitter at the other end of the cable by subtracting the output of the transmitter at the same end of the cable from the signal received by the detector at its end of the cable. Such full duplex, single wire communication channels are well known, and are not essential to implementing the present invention.

Numerous data packets can be simultaneously transmitted through the network. For example consider the example of a first packet being sent from host 332 to host 334 while a second packet is sent from host 336 to host 338. FIG. 7 shows a route P1, comprising three links coupled by two switches which can be used for sending the first packet from host 332 to host 334. Route P2 shown in FIG. 7 can simultaneously be used to send the second packet from host 336 to host 338. In this example, both data packets are simultaneously routed through switch 340. This is possible because the switches used in the present invention are multiported, nonblocking switches. Each switch contains a crossbar circuit which can simultaneously couple a multiplicity of incoming links to distinct outgoing links.

While packets are generally sent from one host H in the network to another host H, it is noted that during reconfiguration of the network data packets are sent to computers in the switches themselves.

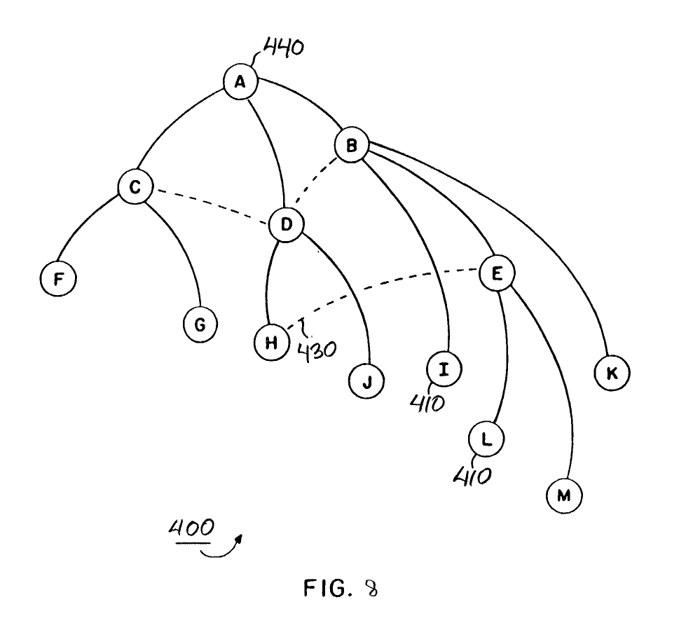

FIG. 8 shows a spanning tree 400 that logically represents the network 200 of FIG. 6. In the graph 400, nodes 410 represent the switches, and edges 430 represent the links. Edge 430 represents the cross-link 230 in FIG. 6. Node 440 represents the root of the spanning tree 400. Although parts of the invention are described with reference to the logical representation of the network 200 in the spanning tree 400 for clarity, it should be clear that in practical applications, the nodes and edges of the spanning tree are nothing more than high-speed electronic switches and communication paths.

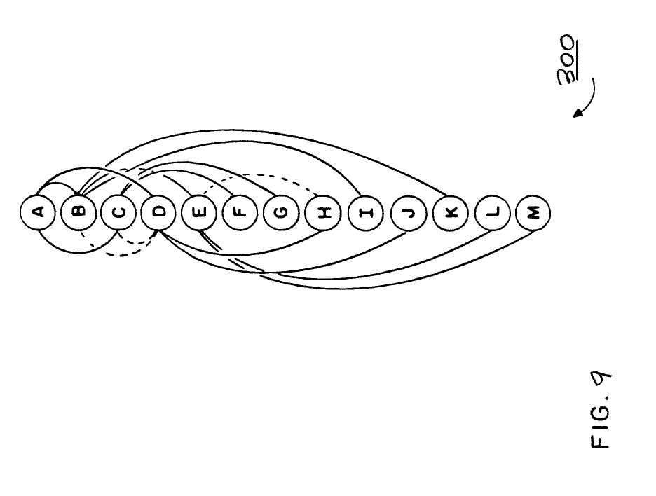

As in the Autonet described above, packets are forwarded according to an up/down rule based on the spanning tree. The up/down rule is easily explained with reference to FIG. 9. Here, the nodes and links are put in some arbitrary order, for example, by name, address, location, or some other identification. An originating point-to-point packet is forwarded to its intended destination by following some number of links in the upward direction, then following some number of links in the downward direction.

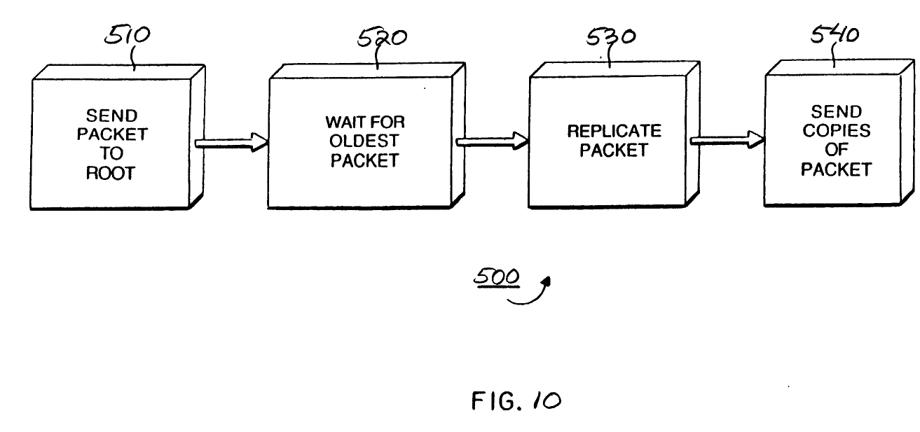

FIG. 10 shows the steps of a method for broadcasting packets in a cut-through network that avoids deadlocks. In step 510, a broadcast packet is forwarded all the way up to the root node. From the root node the packet descends down the links to leaf nodes with replication at all branching nodes. However, with the invention, cross-links are also used during a broadcast. The cross-links can be oriented in any arbitrary manner as long as “loops” are avoided. As stated above, cross-links are not part of the spanning tree.

At this point for the purpose of this description, the root node can be considered an initial “current” node. In step 520, the switch at the current node waits until the oldest packet on each of the switch's incoming downward links is a packet of a descending broadcast. After the oldest packet has arrived at the current node, the packet is replicated for each of outgoing downward links in step 530. The replicated copies of the broadcast packet are sent out on the current switch on all of the outgoing downward links in step 540. Note, when the current node is the root node, the sending can take place immediately since there is only one incoming copy of the packet.

Because the current switch serializes broadcasts, only one broadcast packet at a time starts descending the spanning tree from the root, and the oldest descending broadcast packet on each of the incoming downward links must be a copy of the same packet. When the oldest packet on each of the switch's incoming downward links is a descending broadcast, the switch has a complete match of copies of descending broadcast packets on all of its incoming downward links. The switch is now ready to forward the descending broadcast packet.

In step 540, the switch can forward a copy of the packet from an arbitrary one of the incoming downward links, and discards the other copies of the packet. The switch forwards the descending broadcast packet—simultaneously on all of its outgoing downward links, including cross-links.

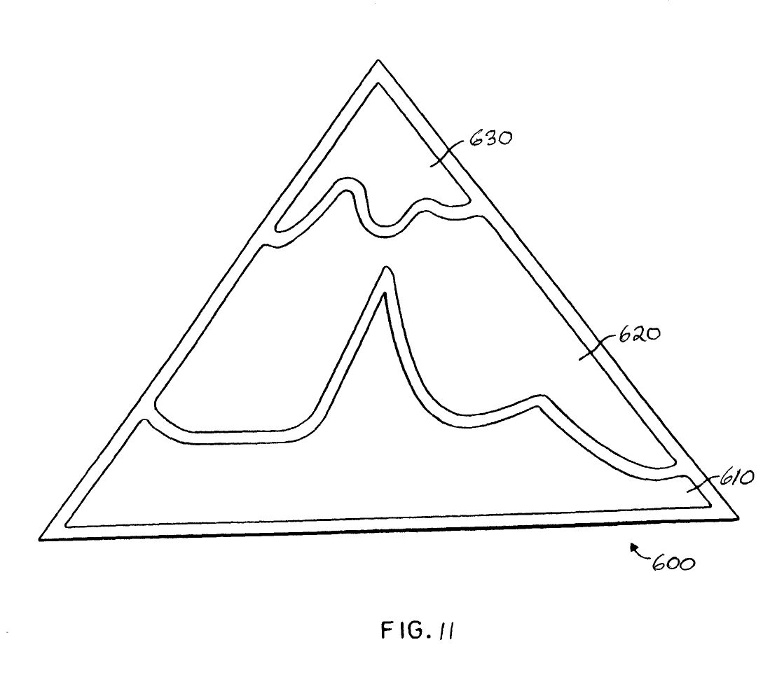

The effect of serializing broadcasts can be visualized in FIG. 11. Here, the spanning tree is represented by a triangle 600. Areas 610, 620, and 630 are portions of the spanning tree occupied by serialized broadcasts, for example, all packets in area 610 belong to the same broadcast, and area 620 is occupied by packets of a next broadcast. As long as current nodes wait for the oldest packet of a broadcast, the areas 610, 620, and 630 will never overlap, and consequently deadlocks are avoided.

The following variations and embellishments can be incorporated. Some of these are useful in dealing with faults, and initialization of the network. First, as an optimization, copies of broadcast packet are only forwarded on spanning tree links, and not on cross-links. The cross-links carry small “tokens” representing the packet, not the entire packet itself. For example, the token can just be the header information sufficient to identify the broadcast packet.

Alternatively, a switch having multiple incoming links discards all but one copy of the descending broadcast packets, for example, only the last copy. When all copies have arrived, the retained copy of the packet is forwarded.

In any network, failures to receive a packet are expected. A failure can be due to a complete loss or corruption of a packet on the network. In addition, the network may encounter spurious packets. In the case of a failure, a switch may get stuck waiting for all of the copies of a broadcast packet.

This is a serious problem because, as described herein, switches can only forward or discard the oldest packet. Indeed, a consequence of a failure, large portions of the entire network may become stuck in a chain reaction through flow-control back-pressure.

One solution to this problem is for the switch to use a time-out value to detect being stuck. When a predetermined amount of time has passed, the switch can clear the problem by initializing the entire network, i.e., the network is re-booted.

Initialization is an acceptable remedy when communication errors are infrequent. However, the time-out value must be set long enough to avoid false alarms possibly due to transient network congestion and low enough to detect stuck states without too much delay. An appropriate choice for the time-out value would be comparable with the amount of time it takes to reboot the network.

A failure can also result in a state where each of the oldest packets on each of downward links to a switch is a broadcast packet, but the oldest packets do not necessarily belong to the same broadcast. In this situation, there is a mismatch on the broadcast packets.

If new broadcast packets enter the network quickly enough, then a switch may never remain stuck long enough to time out, and could continue to mismatch broadcasts. This is a serious problem because the system would be operating in an inconsistent state, which could result in: incorrect behavior such as some leaf-nodes seeing omission of some broadcast packets and repetition of others; and unreasonably poor throughput in the network because a switch could spend most of its time stuck, although never long enough to time out. In the latter case, the switch would be stuck not for any reason of network congestion, which could be deemed reasonable, but because the state of the system is inconsistent.

Mismatched broadcasts can be detected as follows. Each broadcast packet has an associated identifier so that all packets that are present in the network at any one time are uniquely identifiable with a particular broadcast. Given the packet identifier, each switch associates the identifier with a broadcast.

In the case of a mismatch, the switch can clear the problem by re-booting the network. The identifier can be inserted in a packet at any point before the spanning-tree root node forwards the descending broadcast. One method is to have the root switch write a sequence number into each broadcast packet just prior to forwarding it. Another method is to have the original sender write a sequence number and a unique identifier of the sender in each packet. Hash codes can be used to reduce the number of bits required for the identifier.

### INITIALIZATION

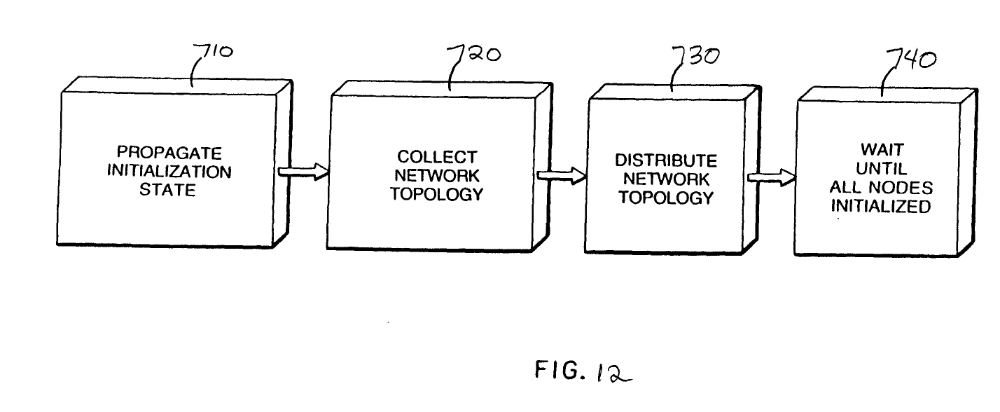

Initialization, foremost, requires that the network be put into a consistent state. According to the invention, initialization proceeds in four phases, as shown in steps 710, 720, 730, and 740 of FIG. 12.

(1) propagating of an initialization state to all switches which clears all packets, and erases all routing information in step 710;

(2) collecting the network topology in step 720;

(3) distributing the network topology to all switches in step 730; and

(4) waiting until all switches are initialized before resuming operation in step 740. After a switch obtains the new topology, in step 730, the switch determines new routing information, and resumes processing packets. In general, initialization can happen at different switches at different times, and initialization could cause a switch A to forward a packet to a switch B that has not yet been initialized. In this case, switch B will discard the packet.

In the prior art network, this may have been acceptable. However, in the context of this description, this is not acceptable because discarding a “descending” broadcast packet may result in an inconsistent network state resulting in an endless cycle of re-boots.

Therefore, during the fourth phase of the initialization according to the invention, nodes report that they are ready to handle descending-broadcast packets, and the spanning-tree root discards, rather than forwards as in the prior art, all broadcast packets until the completion of this additional fourth phase.

The techniques described above guarantee that when a broadcasting switch wants to acquire a resource, it holds all immediately upstream resources. No other packets can hold a resource and at the same time desire to hold an upstream resource. Hence, the system cannot suffer deadlock.

These techniques do not impose any restriction on the maximum length of a broadcast packet, nor any restriction relating the maximum length of a broadcast packet to the minimum size of a switch input buffer.

The foregoing description has been directed to specific embodiments of this invention. It will be apparent, however, That variations and modifications may be made to the described embodiments, with the attainment of all or some of the advantages. Therefore, it is the object of the appended claims to cover all such variations and modifications as come within the spirit and scope of the invention.

What is claimed is:

1. A switch in a network being logically represented by a spanning tree with cross-links, wherein the spanning tree identifies a root switch and a plurality of other switches, the switch comprising:
means for receiving at a current switch a copy of a broadcast packet of a broadcast from each switch for which the current switch is a descendent switch;
means for selecting a copy of the broadcast packet of the broadcast; and
means for forwarding copies of the selected copy of the broadcast packet of the broadcast to all descendents of the current switch.

2. A switch as recited in claim 1, wherein the means for receiving includes a plurality of switch ports, each port being configured to connect to a link in the network.

3. A switch as recited in claim 1, wherein the means for selecting includes a routing control circuit that control the routing of packets in the switch.

4. A switch as recited in claim 1,
wherein the means for receiving includes a plurality of switch ports, each port being configured to connect to a link in the network; and
wherein the means for forwarding includes a crossbar connection unit that is configured to interconnect the switch ports.

5. A switch for a mesh-connected network, that is logically represented by a spanning tree with cross-links, the spanning tree identifying therein a root switch and a plurality of other switches, the switch comprising:
a plurality of switch ports that are each configured to connect to a link in the network and to receive, in a broadcast, from a connected link, a copy of a broadcast packet from each switch for which the switch is a descendent switch;
a crossbar connection unit that is connected to the routing logic circuit and the plurality of switch ports, and configured, in a broadcast, to forward, from a selected switch port, copies of the broadcast packet of the broadcast to any ports having connected links to descendents of the switch in the network; and
a routing logic circuit that is connected to the crossbar connection unit to control the routing of packets in the crossbar connection unit, and configured, in a broadcast, to select one of the switch ports that has a copy of the broadcast packet of the broadcast and any other ports as output ports for transmitting the selected copy of the broadcast packet to descendents of the switch.

6. A switch as recited in claim 5, wherein the crossbar connection unit is configured to forward copies of the selected copy of the broadcast packet simultaneously.

7. A switch as recited in claim 5,
wherein a link connected to the switch is a cross-link to a switch for which the switch is a descendent switch; and
wherein a copy of the broadcast packet sent on the cross-link is represented by a token that identifies the broadcast packet.

8. A switch as recited in claim 7, wherein the token includes header information that identifies the broadcast packet.

9. A switch as recited in claim 5, wherein the crossbar unit is configured, prior to forwarding copies of the selected copy of the broadcast packet, to retain, at the current switch, the selected copy for forwarding; and to discard, at the current switch, all other copies of the broadcast packet.

10. A switch as recited in claim 5,
wherein a port of the switch receives, in a broadcast, a copy of the broadcast packet from at least one switch for which the switch is a descendent switch after a predetermined amount of time; and
further comprising a switch control processor that is connected to the crossbar connection unit and the routing logic circuit, and configured to detect that a failure occurs if copy of a broadcast packet is received after the predetermined amount of time and to initialize the switch in response thereto.

11. A switch as recited in claim 10, wherein the switch control processor is configured to initialize the switch by:
propagating an initialization state to any other switches that are connected to the switch;
collecting network topology information from any other switches that are connected to the switch;
distributing the network topology information to the other switches; and
waiting until all switches in the network are initialized before resuming normal operation.

12. A switch as recited in claim 5, wherein the routing logic unit is configured to recognize at least two concurrent but separate broadcasts in the network.

13. A switch as recited in claim 12,
wherein each separate broadcast has an identifier in each broadcast packet associated with the broadcast; and
wherein the routing logic unit is further configured to recognize broadcast packets as belonging to one of the at least two broadcasts by being further configured to examine the identifier in the broadcast packet.

14. A method for broadcasting packets as recited in claim 13, wherein the identifier incorporated into each copy of the broadcast packets for each identified broadcast is a sequence number.

15. A method for broadcasting packets as recited in claim 13, wherein the identifier in each broadcast is unique to the broadcast.

16. A switch as recited in claim 12,
further comprising a switch control processor that is connected to the crossbar connection unit and the routing logic unit, and configured to initiate a broadcast in response to a request from a host connected to the switch; and
wherein the switch control processor is further configured to include a unique identifier in a broadcast packet to distinguish the broadcast from the at least one other broadcast in the network.

17. A switch as recited in claim 5, wherein the crossbar connection unit is further configured to start the forwarding of copies of the selected copy of the broadcast packet of the broadcast to all descendents of the switch before storing a complete copy of the broadcast packet from each from each switch for which the switch is a descendent switch.

18. A switch as recited in claim 5, wherein the crossbar connection unit and routing logic circuit are each further configured to forward point-to-point packets in the switch concurrently with forwarding broadcast packets in the switch.

19. A mesh connected network for interconnecting a plurality of hosts, the network comprising:
a plurality of switches for routing data packets between hosts in the network; and
a plurality of point-to-point links, each providing a connection between a pair of switches or between a switch and a host in the network;
wherein each switch includes:
a plurality of switch ports that are each configured to connect to a link in the network and to receive, in a broadcast, from a connected link, a copy of a broadcast packet from each switch for which the switch is a descendent switch;
a crossbar connection unit that is connected to the routing logic circuit and the plurality of switch ports, and configured, in a broadcast, to forward, from a selected switch port, copies of the broadcast packet of the broadcast to any ports having connected links to descendents of the switch in the network; and
a routing logic circuit that is connected to the crossbar connection unit to control the routing of packets in the crossbar connection unit, and configured, in a broadcast, to select one of the switch ports that has a copy of the broadcast packet of the broadcast and any other ports as output ports for transmitting the selected copy of the broadcast packet to descendents of the switch.
